(19) United States
(12) Patent Application Publication
(10) Pub. No.: US 2003/0132919 A1
(43) Pub. Date: Jul. 17, 2003

(54) Assembly of a computerized device capable of further operation only after identifying a touch pen exclusive thereto

(75) Inventor: Wei-Pin Chuang, Teipei City (TW)

Correspondence Address: BACON & THOMAS, PLLC, 625 SLATERS LANE, FOURTH FLOOR, ALEXANDRIA, VA, 22314

(73) Assignee: COMPAL ELECTRONICS, INC., Taipei City (TW)

(21) Appl. No.: 10/046,252

(22) Filed: Jan. 16, 2002

(51) Int. Cl. G09G 5/00

(52) U.S. Cl. 345/173

(57) ABSTRACT

A touch pen has a data recording member mounted in a pen barrel for storing identification data. A computerized device includes a data reading unit capable of reading the identification data stored in the data recording member when the data recording member of the touch pen is disposed in close proximity to the data reading unit, a memory unit for storing reference identification data, and a processor coupled to a touch control panel that is mounted on a housing, the data reading unit and the memory unit. The processor is operable so as to receive the identification data from the data reading unit and to verify if the identification data corresponds to the reference identification data, and permits further operation of the computerized device only after identifying that the identification data corresponds to the reference identification data.

### BACKGROUND OF THE INVENTION

1. Field of the Invention

The invention relates to an assembly of a computerized device and a touch pen, more particularly to an assembly of a computerized device capable of further operation only after identifying a touch pen exclusive thereto.

2. Description of the Related Art

FIG. 1 illustrates a conventional personal digital assistant 10 having a touch control panel 14 and a plurality of function keys 11, 12. A touch pen 13 is provided for operating the touch control panel 14 of the conventional personal digital assistant 10. Generally, the conventional personal digital assistant 10 is used for storing conventional data. As such, there is always a need to prevent unauthorized access to the confidential data stored in the conventional personal digital assistant 10.

### SUMMARY OF THE INVENTION

Therefore, the object of the present invention is to provide an assembly of a computerized device capable of further operation only after identifying a touch pen exclusive thereto.

According to the present invention, an assembly comprises:

a touch pen having a pen barrel, and a data recording member mounted in the pen barrel for storing identification data; and

a computerized device including

a housing,

a touch control panel mounted on the housing,

a data reading unit disposed in the housing and capable of reading the identification data stored in the data recording member of the touch pen when the data recording member of the touch pen is disposed in close proximity to the data reading unit,

a memory unit disposed in the housing for storing reference identification data, and

a processor disposed in the housing and coupled to the touch control panel, the data reading unit and the memory unit, the processor being operable so as to receive the identification data from the data reading unit and to verify if the identification data corresponds to the reference identification data, the processor permitting further operation of the computerized device only after identifying that the identification data corresponds to the reference identification data.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a conventional assembly of a personal digital assistant and a touch pen;

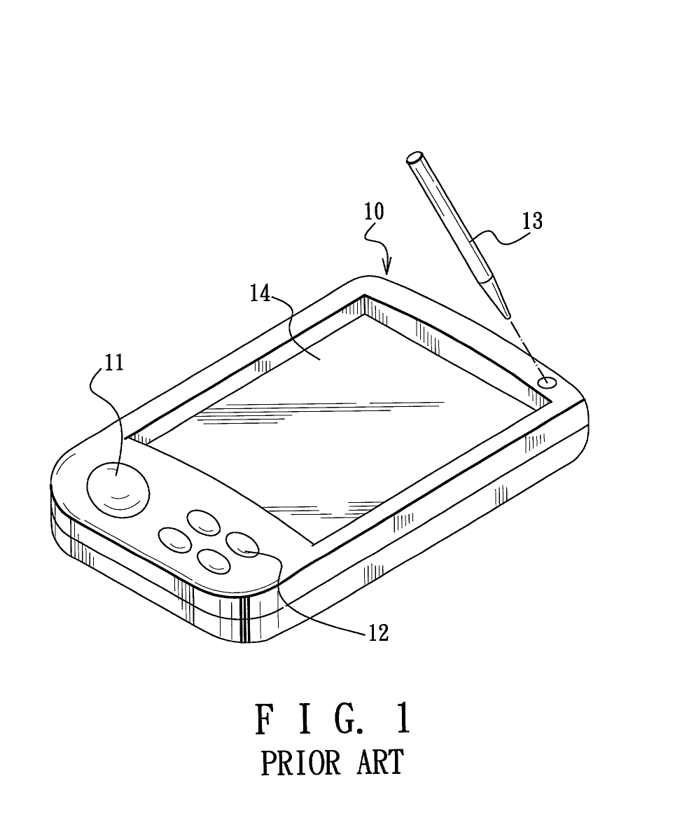

FIG. 2 is a perspective view showing the preferred embodiment of an assembly of a computerized device and a touch pen according to the present invention;

FIG. 3 is an exploded perspective view showing the touch pen of the preferred embodiment; and

FIG. 4 is a schematic circuit block diagram illustrating the assembly of the preferred embodiment.

### DETAILED DESCRIPTION OF THE PREFERRED EMBODIMENT

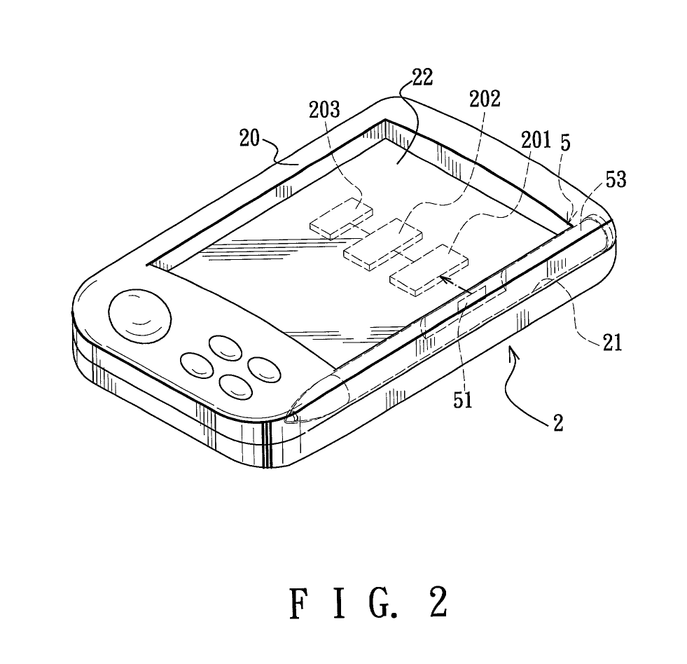

Referring to FIG. 2, the preferred embodiment of an assembly according to the present invention is shown to include a touch pen 5, and a computerized device 2.

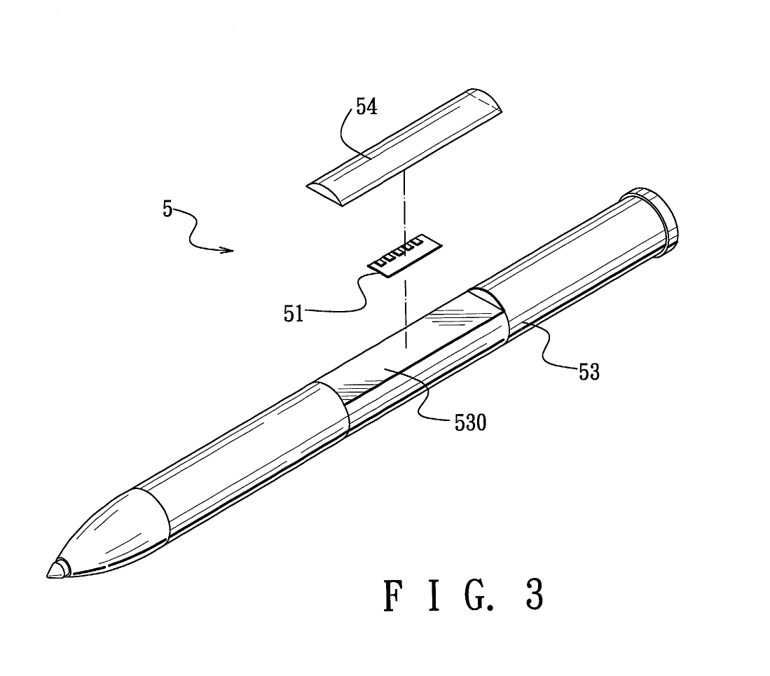

As shown in FIG. 3, the touch pen 5 has a pen barrel 53 formed with an opening 530, a data recording member 51, such as a magnetic card, mounted in the pen barrel 53 via the opening 530 for storing identification data, such as a code exclusive to the touch pen 5, in a known manner, and a cover 54 disposed on the pen barrel 53 to cover the opening 530.

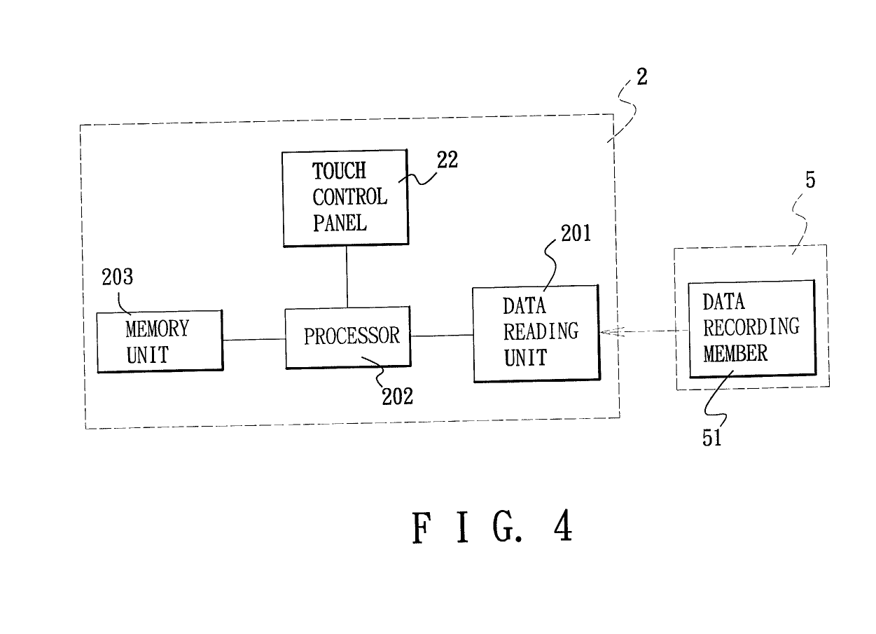

With reference to FIG. 4, the computerized device 2, such as a personal digital assistant, includes a housing 20, a touch control panel 22, a data reading unit 201, a memory unit 203 and a processor 202. The housing 20 is formed with a receiving groove 21 for receiving the touch pen 5. The touch control pen 22 is mounted on the housing 20. The data reading unit 201, such as a magnetic card reader, is disposed in the housing 20 and is capable of reading the identification data stored in the data recording member 51 of the touch pen 5 when the touch pen 5 is received in the receiving groove 21 so as to dispose the data recording 51 of the touch pen 5 in close proximity to the data reading unit 201. The memory unit 203 is disposed in the housing 20 for storing reference identification data. The processor 202 is disposed in the housing 20, and is coupled to the touch control panel 22, the data reading unit 201 and he memory unit 203. The processor 202 is operable so as to receive the identification data from the data reading unit 201 and to verify if the identification data corresponds to the reference identification data. The processor 202 permits further operation of the computerized device 2 only after identifying that the identification data corresponds to the reference identification data. Particularly, the processor 202 activates the touch control panel 22 so as to enable the touch pen 5 to operate the touch control panel 22 only after identifying that the identification data corresponds to the reference identification data. The computerized device 2 is shut down by the processor 202 after identifying that the identification data does not correspond to the reference identification data. As such, the computerized device 2 of the assembly of this invention is capable of further operation only after identifying the touch pen 5 exclusive thereto. In this way, when the computerized device 2 is misplaced, as long as the touch pen 5 remains in the possession of the owner of the assembly of this invention, unauthorized access to confidential data stored in the computerized device 2 can be denied.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An assembly, comprising:
a touch pen having a pen barrel, and a data recording member mounted in said pen barrel for storing identification data; and
a computerized device including
a housing,
a touch control panel mounted on said housing,
a data reading unit disposed in said housing and capable of reading the identification data stored in said data recording member of said touch pen when said data recording member of said touch pen is disposed in close proximity to said data reading unit,
a memory unit disposed in said housing for storing reference identification data, and
a processor disposed in said housing and coupled to said touch control panel, said data reading unit and said memory unit, said processor being operable so as to receive the identification data from said data reading unit and to verify if the identification data corresponds to the reference identification data, said processor permitting further operation of said computerized device only after identifying that the identification data corresponds to the reference identification data.

2. The assembly as claimed in claim 1, wherein said processor permits further operation of said computerized device by activating said touch control panel so as to enable said touch pen to operate said touch control panel only after identifying that the identification data corresponds to the reference identification data.

3. The assembly as claimed in claim 1, wherein said data recording member is a magnetic card.

4. The assembly as claimed in claim 3, wherein said data reading unit includes a magnetic card reader.

5. The assembly as claimed in claim 1, wherein the identification data is a code exclusive to said touch pen.

6. The assembly as claimed in claim 1, wherein said computerized device is a personal digital assistant.
